(19) United States
(12) Patent Application Publication
(10) Pub. No.: US 2014/0046876 A1
(43) Pub. Date: Feb. 13, 2014

(54) SYSTEM AND METHOD OF PROVIDING A COMPUTER-GENERATED RESPONSE

(71) Applicants: Yitao Zhang, Hurtsville (AU); Lukie Ali, North Strathfield (AU)

(72) Inventors: Yitao Zhang, Hurtsville (AU); Lukie Ali, North Strathfield (AU)

(73) Assignee: MORF DYNAMICS PTY LTD, Sydney, New South Wales (AU)

(21) Appl. No.: 13/805,867

(22) PCT Filed: Jun. 30, 2011
(86) PCT No.: PCT/AU11/00814

§ 371 Date: Mar. 27, 2013

(30) Foreign Application Priority Data
Jun. 29, 2010 (AU) 2010902865

(51) Int. Cl. G06N 3/08

(52) U.S. Cl. CPC G06N 3/08
USPC 706/11

(57) ABSTRACT

The present invention generally concerns a method and a system for providing a computer-generated response in response to natural language inputs. The response includes, but is not limited to, visual, audio, and textual forms. The response is capable of being displayed or shown in a visual 2- or 3-dimensional virtual world. In one aspect, the present invention provides a method of providing a computer-generated response, including the steps of (i) receiving a computer-recognisable input originating from a user of a computer-simulated environment for facilitating interaction between the user and a simulated character controlled by a controller, (ii) extracting input information from the computer-recognisable input as extracted input information at least partly by linguistic analysis or semantic analysis and (iii) causing an action to be generated in response to the computer-recognisable input based at least partly on the extracted input information.

### FIELD OF THE INVENTION

The present invention relates generally to a system and a method of providing a computer-generated response, and particularly to a system and a method of providing a computer-generated response in a computer-simulated environment.

### BACKGROUND OF THE INVENTION

With the rapid growth of computer-simulated environments such as on-line virtual worlds, causal gaming and the social web (for example, Facebook, Second Life and SmallWorlds), there is a growing demand for an improved communication interface to interact with users of the computer-simulated environments. For instance, a virtual character may appear robotic or computerised if it does not understand the interrogations of a user in either a spoken or written natural language form, or if it does not reply with a meaningful response.

Early efforts on controlling virtual characters in on-line virtual worlds to provide computer-generated responses, such as ALICE chat-bot, generally rely on keyword and pattern matching. As a result, early communication interfaces lack the ability to interpret user inputs or interrogations as commands or requirements for actions.

### SUMMARY OF THE INVENTION

According to one aspect of the present invention there is provided a system for providing a computer-generated response, the system comprising a processor programmed to:
receive a computer-recognisable input originating from a user of a computer-simulated environment for facilitating interaction between the user and a simulated character controlled by a controller;
extract input information from the computer-recognisable input as extracted input information at least partly by linguistic analysis or semantic analysis; and
cause an action to be generated in response to the computer-recognisable input based at least partly on the extracted input information.

According to another aspect of the present invention there is provided a method of providing a computer-generated response, the method comprising the steps of:
receiving a computer-recognisable input originating from a user of a computer-simulated environment for facilitating interaction between the user and a simulated character controlled by a controller;
extracting input information from the computer-recognisable input as extracted input information at least partly by linguistic analysis or semantic analysis; and
causing an action to be generated in response to the computer-recognisable input based at least partly on the extracted input information.

Preferably the step of extracting input information at least partly by linguistic analysis includes the step of converting non-text-based information into text-based information. More preferably the step of converting non-text-based information into text-based information includes converting speech into text-based information.

Preferably the step of extracting input information at least partly by linguistic analysis includes the step of identifying spelling errors. More preferably the step of identifying spelling errors includes the step of correcting the spelling errors.

Preferably the step of extracting input information at least partly by linguistic analysis includes the step of extracting input information by syntactic analysis. More preferably the step of extracting input information by syntactic analysis includes the step of analysing the input information by any one or more of part-of speech tagging, chunking and syntactic parsing.

Preferably the step of extracting input information at least partly by semantic analysis includes the step of associating each of one or more syntactic units in the input information with a corresponding semantic role.

Preferably the step of extracting information includes the step of extracting fact information. More preferably the step of extracting fact information includes determining any one or more of the user's age, company or affiliation, email address, favourites, gender, occupation, marital status, sex orientation, nationality, name or nickname, religion and hobby.

Preferably the step of extracting information includes the step of extracting emotion information. More preferably the step of extracting emotion information includes the step of determining if the user feels angry, annoyed, bored, busy, cheeky, cheerful, clueless, confused, disgusted, ecstatic, enraged, excited, flirty, frustrated, gloomy, happy, horny, hungry, lost, nervous, playful, sad, scared, regretful, surprised, tired or weary.

Preferably the step of receiving a computer-recognisable input includes the step of receiving a computer-recognisable input generated using an input device. More preferably the step of receiving a computer-recognisable input generated using an input device includes the step of receiving a computer-recognisable input generated using any one or more of a keyboard device, a mouse device, a tablet hand-writing device and a microphone device.

Preferably the step of causing an action to be generated includes the step of causing a task to be performed. More preferably the step of causing a task to be performed includes the step of causing a business operation to be performed. Even more preferably the step of causing a business operation to be performed includes the step of causing the balance of a financial account of the user to be checked. Alternatively or additionally the step of causing a business operation to be performed includes the step of causing a financial transaction to take place

Preferably the step of causing a task to be performed includes the step of facilitation booking and reservation of on-line accommodation and/or on-line transport.

Preferably the step of causing an action to be generated includes the step of causing content to be delivered to the user. More preferably the step of causing content to be delivered includes the step of causing any one or more of text, an image, a sound, music, an animation, a video and an advertisement to be delivered to the user.

Preferably the step of causing content to be delivered to the user includes causing content to be delivered via an output device. More preferably the step of causing content to be delivered via an output device includes the step of causing content to be delivered via a computer monitor or a speaker.

Preferably the step of causing an action to be generated includes the step of causing an emotion of the simulated characters to be generated based at least partly on the extracted information. More preferably the step of causing an action to be generated includes the step of providing the emotion of the simulated character to the user.

Preferably the step of causing an action to be generated includes the step of comparing the extracted input information to a plurality of predetermined actions. More preferably the step of comparing includes identifying one or more matches or similarities between the extracted input information and one or more of the plurality of predetermined actions. Even more preferably the step of identifying one or more matches or similarities includes the step of identifying one or more matches or similarities on words, patterns of words, syntax, semantic structures, facts and emotions between the extracted input information and the one or more of the plurality of predetermined actions.

Preferably the step of comparing includes the step of ranking the one or more of the plurality of predetermined actions. More preferably the step of ranking includes the step of associating a ranking score to each of the one or more of the plurality of predetermined actions.

Preferably the step of causing an action to be generated includes the step of retrieving at least one of the one or more of the plurality of predetermined actions. More preferably the step of retrieving at least one of the one or more of the plurality of predetermined actions includes the step of retrieving at least one of the one or more of the plurality of predetermined actions based at least partly on the ranking score. Even more preferably the step of retrieving at least one of the one or more of the plurality of predetermined actions based at least partly on the ranking score includes the step of retrieving one or more predetermined actions each with a ranking score larger than a threshold ranking score.

Preferably the plurality of predetermined actions includes a plurality of manually compiled actions or machine learned actions.

Preferably the method further comprises the steps of:
extracting interaction information from interaction between the user and a character as extracted interaction information, the character being one of a plurality of user characters controlled by a plurality of respective users, or one of a plurality of simulated characters controlled by a plurality of respective controllers; and
storing the extracted interaction information in a user profile associated with the user.

More preferably the step of causing an action to be generated includes the step of causing an action to be generated based at least partly on the user profile.

Preferably the step of extracting interaction information includes the step of extracting interaction information at least partly by linguistic analysis or semantic analysis. More preferably the step of extracting interaction information at least partly by linguistic analysis or semantic analysis includes the step of ranking information associated with user actions and stored in the user profile according to frequencies of the user actions.

Preferably the method further comprises the step of updating the user profile by repeating the steps of extracting interaction information and storing the extracted interaction information.

Preferably the step of causing an action to be generated includes determining inconsistencies between the extracted input information and the user profile. More preferably the step of causing an action includes, if an inconsistency is determined to exist, the step of generating a query associated with the inconsistency to the user.

Preferably the step of storing the extracted interaction information in a user profile associated with the user includes storing the user profile in an electronic database.

Preferably the user profile includes fact information about the user and/or personal characteristics about the user.

Preferably the method further comprises the steps of:
allocating the user to a user group having a plurality of group users sharing similar or same interaction information stored in a plurality of respective user profiles; and
storing the similar or same interaction information in a user group profile associated with the user group.

Preferably the step of causing an action to be generated includes causing an action to be generated based at least partly on the user group profile.

Preferably the computer-simulated environment includes any one or more of a virtual world, an online gaming platform, an online casino and chat rooms.

Preferably the interaction includes any one or more of conversations, game playing, interactive shopping and virtual world activities.

More preferably the virtual world activities include virtual expos or conferences, virtual educational, tutorial or training events or virtual product or service promotion.

### BRIEF DESCRIPTION OF THE ACCOMPANYING DRAWINGS

FIG. 1: A simplified schematic diagram showing an embodiment of a system according to the present invention.

FIG. 2: A detailed schematic diagram showing the embodiment of a system shown in FIG. 1.

FIG. 3: A flowchart showing an example of linguistic processing.

FIG. 4: A schematic diagram of a virtual world interaction system in accordance with an embodiment of the present invention.

FIG. 5: A flowchart illustrating operations of retrieving a multi-modal script.

FIG. 6: A flowchart illustrating operations of using virtual memory for storing extracted fact information.

FIG. 7: An example illustrating a user interacting with a virtual or simulated character.

FIG. 8: A schematic diagram illustrating an example of a relationship between a neural net system and a virtual world.

FIG. 9: A schematic diagram illustrating the relationship between an enterprise platform and a virtual world.

FIG. 10: A flowchart illustrating operations of a neural net processor.

### DETAILED DESCRIPTION OF THE PREFERRED EMBODIMENTS

The present invention generally concerns a method and a system for providing a computer-generated response in response to natural language inputs. The response includes, but is not limited to, visual, audio, and textual forms. The response is capable of being displayed or shown in a visual 2- or 3-dimensional virtual world. In a specific virtual world application MojiKan, the present invention has been used for creating believable virtual or simulated characters to maintain a rich and interactive gaming environment for users.

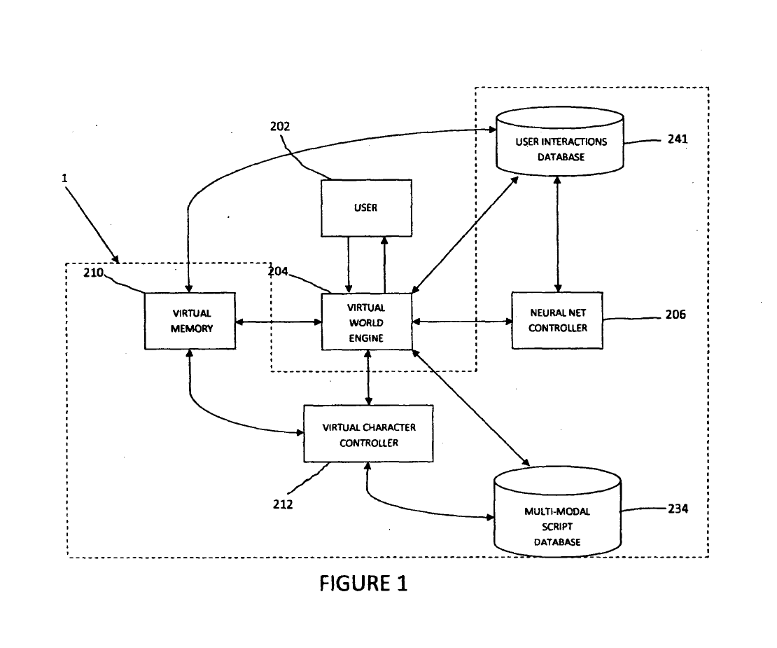

FIG. 1 shows the overall system architecture of an embodiment of the system 1 of the present invention. A user 202 connects to the virtual world server 204 which hosts a computer-simulated environment and which is responsible for establishing a valid communication channel for interaction between the user 202 and a virtual character controlled by a virtual character controller 212. An effective interaction between a user and a virtual character is managed by 212 and is supported by the multi-modal script database 234, the virtual memory 210, and the neural net controller 206 via the virtual world engine 204. Moreover, the natural language processing is handled by 212 as well.

The virtual memory system 210 may provide interfaces for storing and retrieving targeted information extracted from user actions database 241 which is a repository of a user's previous interactions with any virtual characters or other users of the system 1.

The multi-modal script database 234 may store both manually compiled and machine learned commands for generating meaningful responses to the user. The commands cover multiple dimensions of communication forms between the user and the virtual character which include, but are not limited to, textual response, audio response, and 2- or 3-dimensional visual animation.

The Neural Net controller 206 is used to study and to categorise more detailed profiling of user activities. The result is used for both finer-grained language understanding and generation of appropriate responses.

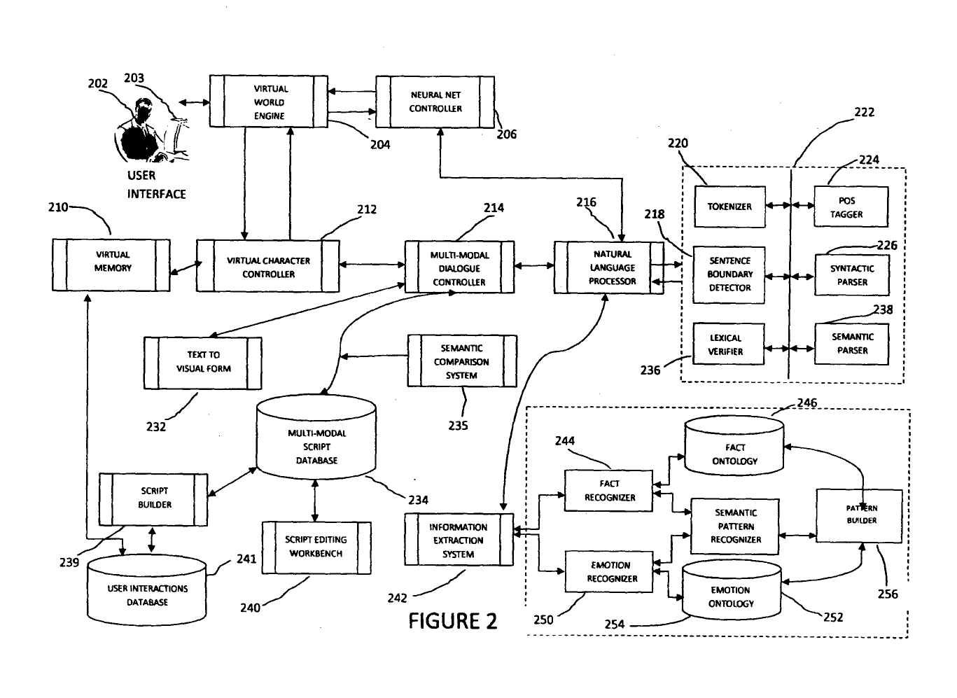

FIG. 2 shows the detailed system architecture of the embodiment of the present invention as shown in FIG. 1. A user interface 203 includes input and output devices which are responsible for collecting user input and displaying responses delivered by the system 1. An input device can be realised as a keyboard device, a mouse device, a tablet hand-writing device, or a microphone device for receiving audio inputs of a user. An output device can be realised as a computer monitor for displaying video and text output signals, or a speaker for exporting audio signal responses from the system.

The user interface 203 may also include necessary interpretation modules which are able to translate various types of user inputs into a unified and consistent written text format which can be stored and recognised by computers of the system. For instance, a speech recogniser may be needed to transform audio input into text scripts of the speech, or a scanned image which consists of hand-written text message that can be interrelated by an OCR device.

Once the user input has been converted into a computer-recognisable format and submitted to the MojiKan virtual world server 204, which is connected to 203 preferably through a computer network system, the message may be delivered into two different channels, namely, the Neural Net system 206, and the virtual character controller 212.

The Neural Net system 206 is responsible for user personality and characteristics profiling by learning predominantly from a regularly updated user interactions database which records the quantifiable behaviours and acts of a user, and her or his conversation logs and language patterns in on-line communications.

The virtual character controller 212 is responsible for allocating all the necessary resources for analysing and responding to a particular user's input. It also establishes correct communication channels with the virtual world server 204 and Neural Net controller 206, and receives and delivers messages accordingly.

For every virtual or simulated character in the virtual world, the virtual character controller 212 may allocate a dedicated dialogue controller 214 to monitor the interaction with the user. The dialogue controller 214 communicates with a natural language processor 216 for syntactic and semantic analysis of the incoming input (converted to computer-recognisable format if necessary) from the user. The analysed input may be used by an information extraction system 242 for further extraction of targeted information such as person and organisation names, relations among different named entities in texts and the emotion information that are expressed in texts.

The natural language processor 216 uses various linguistic and semantic processing components 222 to extract meaning from the user's input. A tokenizer component 220 may identify word boundaries in texts and split a chunk of texts into a list of tokens or words. A sentence boundary detector 218 may identify the boundaries between sentences in texts. A lexical verifier 236 may be responsible for both detecting and correcting possible spelling errors in texts. A part-of-speech tagger 224 may provide fundamental linguistic analysis functionality by labelling words with their function groups in texts. A syntactic parser 226 may link the words into a tree structure according to their grammatical relationships in the sentence. A semantic parser 238 may further analyse the semantic roles of syntactic units, such as a particular word or phrase, in a sentence.

The information extraction system 242 is built on top of the natural language processor 216. It further uses two specifically trained classifiers, namely, fact recogniser 244 and emotion recogniser 250. Both of the classifiers rely on the semantic pattern recogniser 252. The fact recogniser 244 may recognise fact information such as age, company, email, favourites, gender, job, marital status, sex orientation, nationality, name, religion, zodiac. The emotions such as anger, annoyed, boredom, busy, cheeky, cheerful, clueless, confusion, disgust, ecstatic, enraged, excited, flirty, frustrated, gloomy, happiness, horny, hunger, lost, love, nervous, playful, sadness, scared, sick, sorry, surprise, tiredness, weary.

The fact recogniser 244 targets certain types of information in texts such as the name/nickname, occupation, and hobbies of a user. The targeted information provides important identity or descriptive personal information which can be further used by the system. Fact extraction is supported by a fact ontological resource 246. All the targeted information, along with their attributes and hierarchical structures among the entities, are defined and stored in an XML-based ontology database. Moreover, the fact recogniser 244 uses the semantic pattern recogniser module 252 which can either be created by manually defined semantic pattern rules, or by supervised or semi-supervised machine learning. The pattern builder 256 is used for both manual editing of semantic patterns and creating annotated corpus for supervised or semi-supervised learning of the targeted semantic information. When in a corpus creating mode, the pattern builder imports the definition of the targeted information from the fact ontology and automatically creates an annotation task which considers either the existence or non-existence of targeted information in texts.

Similarly, the emotion recogniser 250 also exploits both an ontological resource 254, and the semantic pattern recogniser 252. It follows the same strategy as the fact recogniser 244 to compile and recognise the targeted emotion information as expressed by a user in texts.

Once the input text message has been analysed by both the natural language processor 216 and information extraction system 242, the dialogue controller 214 is able to gather the relevant information for further retrieval of the most appropriate multi-modal scripts for responses.

A multi-modal script generally refers to pre-written or predetermined commands or actions which can be interpreted and executed by the system 1. For instance, a 3-dimensional animation can be created and stored in the system as an asset before a specific command is called to load and execute the animation on the display unit of a user. A business operation such as checking the balance of the bank account of a particular user can be decomposed into a series of actions which can be defined and carried out or initiated by the system.

These multi-modal responses can either be written manually beforehand, or learned semi-automatically by computers from the real activities of users in a virtual world context. The first approach is preferable when the response is specifically task-driven and requires a rigorous feedback. When trying to deliver advertising or conduct a market survey in a direct one-to-one communication between a user and a virtual character, it is desirable for the virtual character to follow certain pre-defined paths to fulfil its purpose of the conversation task. For instance, if the user is trying to buy a virtual commodity from the virtual character, the system should use the same business logic for handling a real transaction and response to user's request accordingly. If the user has insufficient fund in her or his bank account, the virtual character should respond with, for example, an insufficient balance message and preferably suggests several ways to earn enough money in order to continue the transaction. These pre-defined paths have high business values to the virtual world application and are decided to follow a guided direction during conversations. These pre-defined multi-modal scripts are written with a dedicated script editing workbench 240. The scripts are stored and can be retrieved from a central multi-modal script database 234. Moreover, the retrieval process is supported by a dedicated semantic comparison component 235.

However, there are situations in which the nature of the conversation is less task-driven and more casual, i.e. there is no pre-defined or targeted direction of the conversation. Hence, an automatically or semi-automatically learned conversation script from real user conversations is more appropriate. Hence, a semi-supervised script builder 239 has been created for learning from the user action history database 241. The most common or interesting responses are selected by the system for human selection. The results are also stored in the central multi-modal script database 234.

In order to create believable simulated characters such as virtual pets and non-player characters (NPC), the system further exploits dedicated virtual memory system 210 for each individual virtual pet or NPC. A virtual memory system is responsible for memorising all the interaction information including fact information mentioned by the user during conversations in a user profile, and is connected with the user conversation history database 241. The memorised or stored interaction information may be extracted from the interaction of the user with other users or NPC's by linguistic analysis or semantic analysis. Furthermore individual actions of the user stored in the interaction information may be ranked in the user profile according to frequencies of these user actions. The stored information is useful in triggering or generating specific conversations that is related to the targeted information.

The text to visual form system 232 is created on top of the patent “text to visual form” and is used to directly generate the required visual response in a 2- or 3-dimensional form.

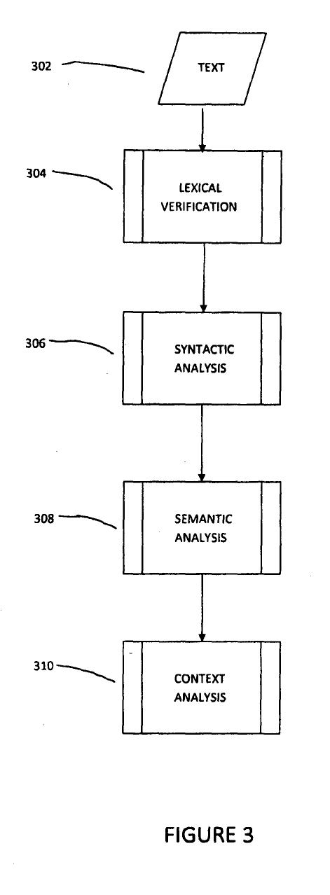

FIG. 3 illustrates a flowchart of steps followed by a linguistic processing module. The user input is first converted into computer-recognisable text 302. The text is first pre-processed with sentence and word boundaries to split sentences and words in a sentence. It will then be passed on to a lexical verification component 304 which identifies possible spelling errors according to dictionary or machine-learned rules. The result is then subject to syntactic analysis 306 which includes part-of-speech tagging, chunking, and syntactic parsing using a formal grammar. Finally, the result is passed on to further semantic analysis 308 and context analysis 310. In semantic analysis, various syntactic units such as phrases or words are filtered by their possible semantic roles in the sentence. For instance, a sentence regards selling of a product may involves a seller, a potential buyer, a product being purchased, and money units involved in the transaction. A FrameNet style semantic analysis will be first identifying the sentence as an actual good purchasing frame, and then assigning different words or phrases in the sentence with their corresponding semantic roles. The goal of context analysis 310 includes tasks like anaphor resolution which links certain references in a sentence like “he” or “the company” to their corresponding referred entities in the context.

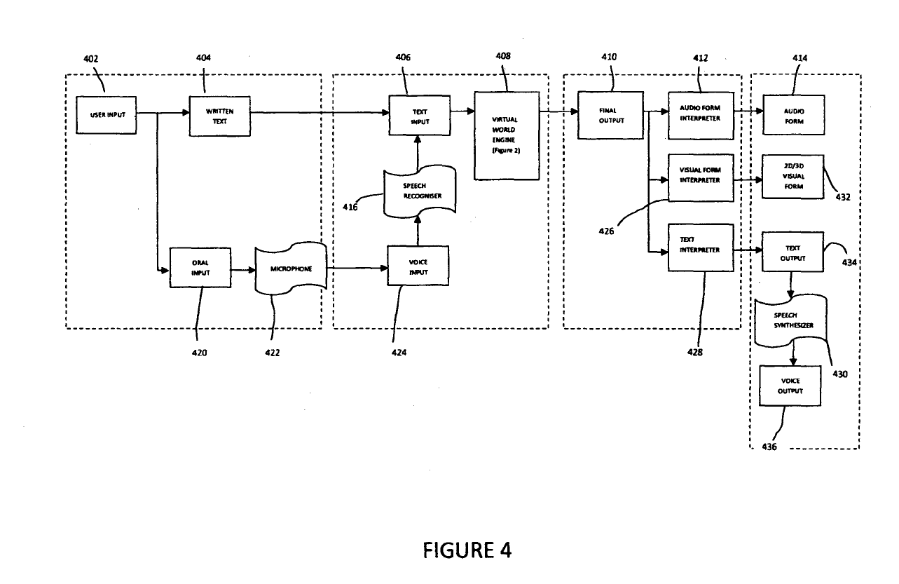

FIG. 4 shows an embodiment of the invention involving an on-line virtual world system 400. The input device may receive two types of inputs, namely, text input 404 and oral input 420. The text input can be received by electronic devices such as keyboards, mouse devices, and mobile phones which are connected to the system via computer networks or mobile phone networks. If the text input is in the form of images, an OCR device is required to extract the text information and export them into a written text form. The oral input can be received by a microphone device 422, and received by the system as an audio input 424. A speech recogniser device 416 can then be used to convert the voice input into the final text input form 406.

The received text input is analysed by the virtual world engine 408. After meanings have been successfully extracted, the virtual world engine 408 will retrieve the most appropriate response script by searching a response script database. The responses in the database are either manually edited, or learned semi-automatically from real conversations or interactions among virtual world users. The detailed language analysis and response retrieve and generation process is shown in FIG. 2. The final response is then generated according to the response script and various related context parameters such as the name and current emotion of the user.

Once the final response 410 has been generated, the system may then provide an appropriate output channel according to information such as the type of user inputs, and the preferred output channel selected by the user. An audio interpreter 412 is able to convert the result into an output audio form 414. A visual form interpreter 426 is able to generate 2- or 3-dimensional visual form 432 according to the final output. Finally, a text interpreter 428 can generate a text output 434, or alternatively to generate a voice output 436 with the help of a speech synthesiser 430.

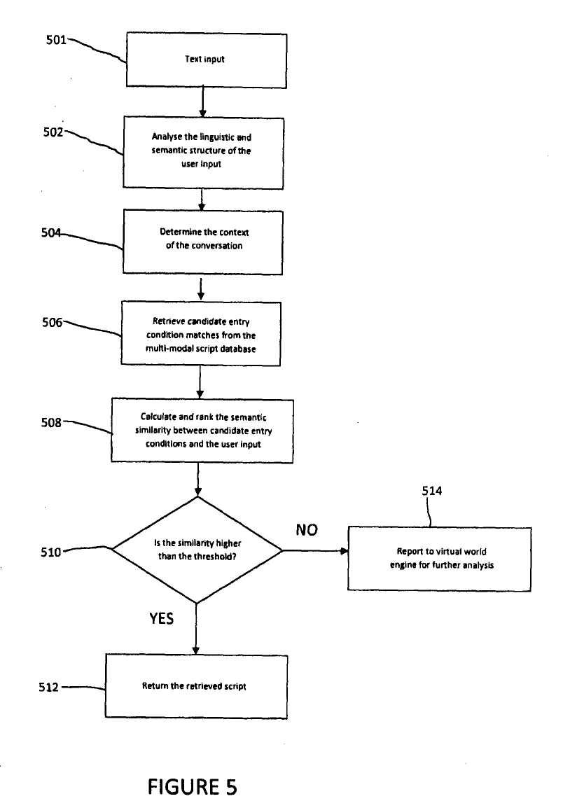

FIG. 5 shows a flowchart of the script retrieval operation from the multi-modal script database. At step 501, the system receives a user input and converts it into an appropriate text input form that can be handled and is computer-recognisable by the system. At step 502, the natural language processor 216 analyses the input text and extracts targeted fact and emotion information as defined in ontological resources 246 and 254. A wide variety of linguistic and semantic analysis may be undertaken in this step, such as lexical verification, part-of-speech tagging, syntactic and semantic parsing. The extracted meaning is returned to the multi-modal dialogue controller 214 for further processing. At step 504, contextual information such as user histories and the current task of the user is considered for processing. At step 506, candidate responses are retrieved by comparing the text input with all the entries in the multi-modal script database. This retrieval step may adopt a relaxed matching criterion which returns any script that shares at least one match point with the user input. A matching point is calculated as any single match between the candidate script and the user input on word, patterns of extracted meaning such as part-of-speech tags, syntactic and semantic parse structures, facts and emotions. At step 508, all the retrieved multi-modal script candidates are ranked by a heuristic rule. The higher the ranking score, the more similar the entry condition of a candidate script to the user input. At step 510, if a candidate script achieved a ranking score which is higher than a pre-defined threshold value, it can be returned as a basis for generating a meaningful response to the user as shown in step 512. Otherwise the input may be returned to the virtual world engine for further analysis in step 514.

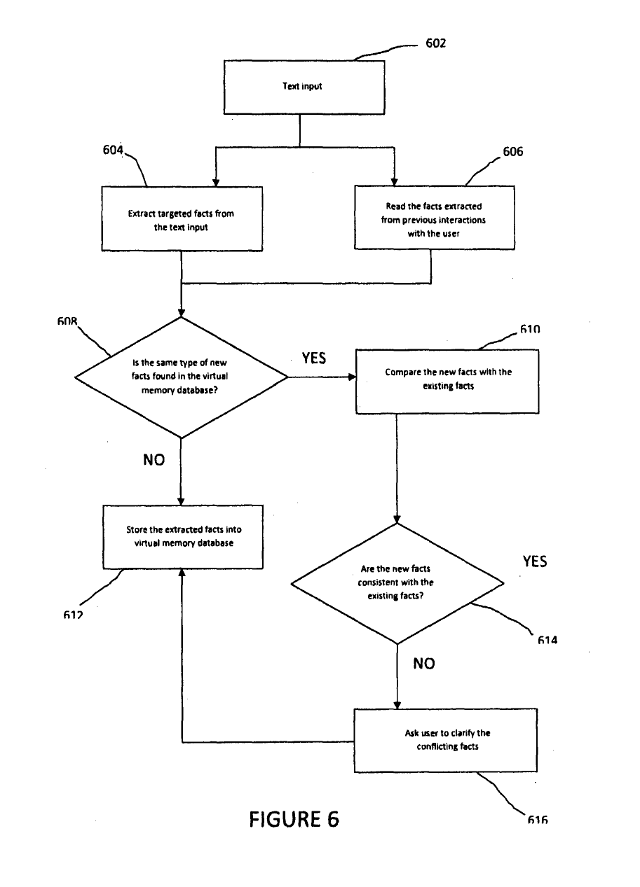

FIG. 6 shows a flowchart of the operation of utilising a virtual memory system for richer user interaction. In FIG. 6, at step 602, the user input has been converted into a computer-recognisable text form. At step 604, natural language processor 216 and information extraction system 242 are used to analyse the semantics and to extract targeted facts from the text. The targeted facts are defined in an ontological resource 246. Meanwhile, at step 606, those facts that are extracted from previous user interaction histories are retrieved. At step 608, the system checks if the same type of facts are already stored in the virtual memory system. If this is the first time that the user mentions this type of fact, the system stores the new facts into the virtual memory database in step 612. If the same type of facts is found in the existing facts, the system compares the newly extracted facts with the existing facts in step 610. At step 614, if the new facts are consistent with the existing facts, the system quits the virtual memory system. If the new facts are inconsistent with the existing facts, the system asks the user to clarify by natural language dialogues. The results maybe stored in the virtual memory database in step 612.

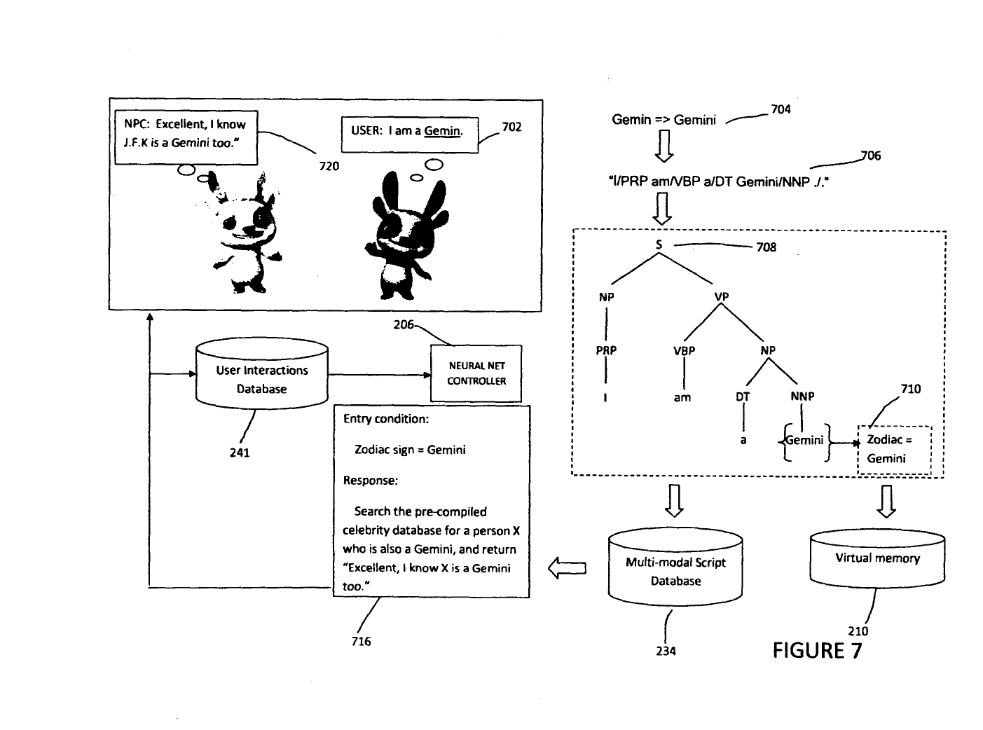

FIG. 7 shows how a multi-modal response can be generated by an embodiment of the present invention during the interaction between a virtual or simulated character and a user. At step 702, the user submits a text input to interact or correspond with a non-player character (NPC) via a computer connected network. The text input is received by the virtual world engine 204, and is then submitted to the natural language processor 216 for linguistic processing. At step 704, the spelling error is identified, and the most likely candidate is returned for further analysis. At step 706, the corrected sentence is submitted for part-of-speech (POS) tagging in which words are assigned with their most appropriate function class labels, such as nouns, verbs, and adjectives. At step 708, the POS-tagged sentence is submitted for syntactic analysis. A context-free grammar is used in the syntactic parsing. The result of syntactic parsing is a tree-structure. At step 710, the analysed sentence is submitted to the fact extractor 244 and emotion extractor 250. The extracted facts are stored in a user profile associated with the user in the virtual memory database 210. At step 716, the analysed user input is compared with the entry conditions in the multi-modal script database 234. The most similar response script is returned as the candidate response script. At step 720, the final response is generated and is returned to the user in the form of a reply from the virtual or simulated character in response to the user text input. The interaction history may be stored in the database 241, and is further sent to the neural net system 206 as new evidence for refined user profiling.

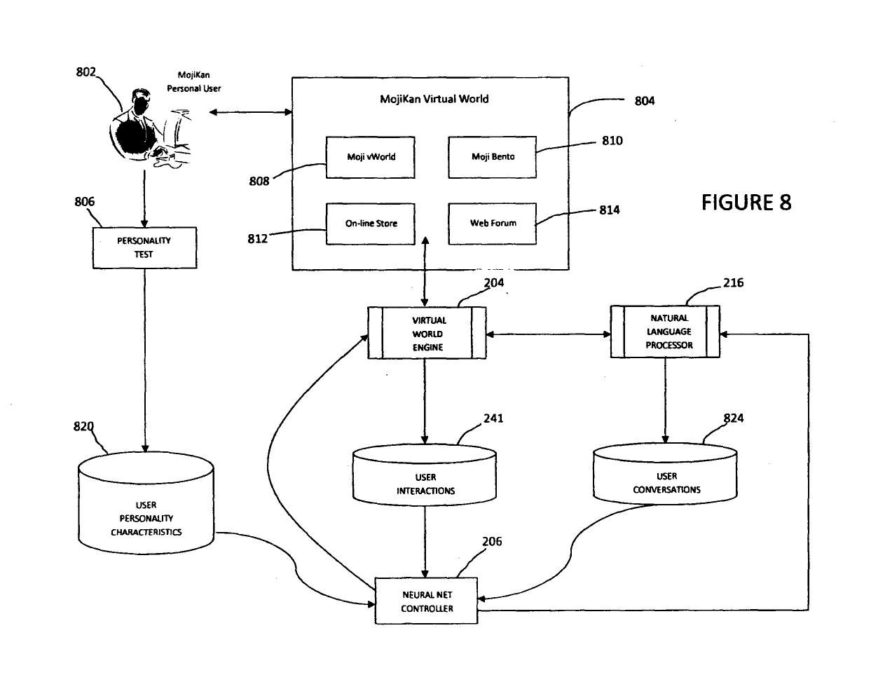

FIG. 8 illustrates an example of the relationship between the neural net component and the MojiKan virtual world system. A MojiKan personal user 802 interacts with the MojiKan virtual world 804 through a variety of applications such as Moji vWorld 808, Moji Bento 810, On-line stores 812, and Web-based user forum 814. Personality test 806 is a stand-alone questionaries system which provides a static view of a user's personality characteristics when she or he first joined the on-line virtual world. The test results are stored in user personality characteristics database 820. The virtual world applications are backed by the virtual world engine 204. The communication is further processed by the natural language processor 216 for linguistic and semantic processing. The neural net controller 206 provides a dynamic user personality profile by combining the static user personality characteristics, and the regularly updated user interactions 241 and user conversations 824. The result is then sent back to the virtual world engine 204 and natural language processor 216 for better understanding of the user.

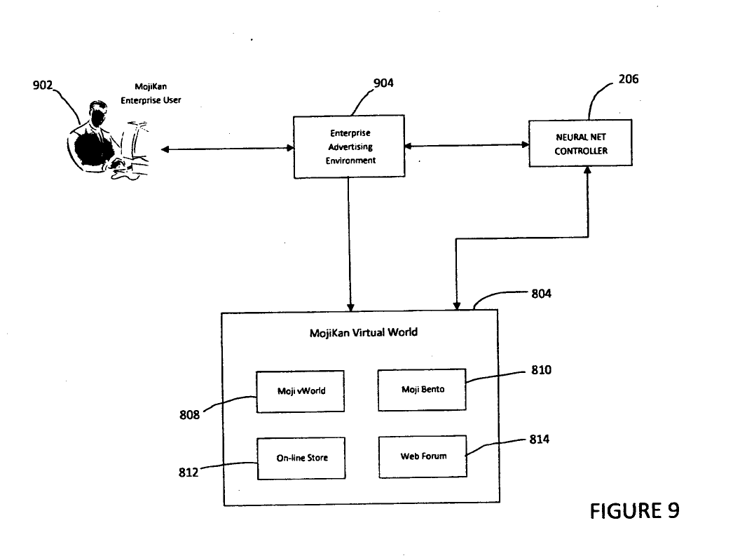

FIG. 9 illustrates an enterprise platform in which targeted advertising can be delivered according to the user characteristics profiling results returned by the Neural Net system. This is an example of a special modality of communication that the present invention can be applied to.

An enterprise user of the virtual world interacts with the enterprise advertising environment 904 which is supported by the Neural Net system 206. The enterprise user is able to conceptualise the advertising campaign by specifying the targeted user personality group. A final advertising content is generated by consulting the Neural Net processor for audiences who match the targeted personality group.

The generated advertising content is delivered to the virtual world 804 through various application components, such as Moji vWorld 808, Moji Bento 810, On-line store 812, and Web forum 814.

In some embodiments, a user may be allocated to a user group with other users sharing the same or similar personality and interaction characteristics, stored in a user group profile. Advertisement may then be delivered to the user based on the user group, rather than solely on the user profile of the user, and optimised for the user group. Hence, the actions and choices of a group user may have a significant impact on the advertisement selection results for other group users in the same group in the MojiKan virtual world.

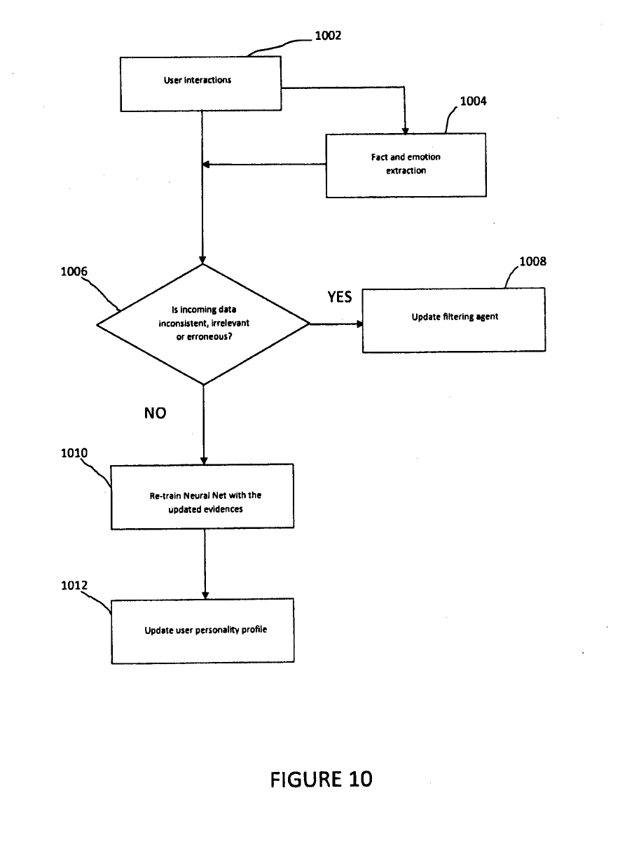

FIG. 10 illustrates the flow chart of the operation of an embodiment of the Neural Net processor. At step 1002, a user's interaction with the virtual world has been recorded. At step 1004, if the interaction is text-based, the information is analysed and the extracted fact and emotion information is returned as another form of input for the Neural Net system. At step 1006, if the incoming user interaction is considered as inconsistent, irrelevant or erroneous by the Neural Net system, it will be sent to update the filter agent which filters out any future irrelevant interactions at step 1008. If the incoming interaction is considered as useful, the Neural Net will update its weights according to the new evidence at step 1010. Finally, at step 1012, the updated Neural Net will update the user profile and store the result in the user profile database.

1. A method of providing a computer-generated response, the method comprising the steps of:
receiving a computer-recognisable input originating from a user of a computer-simulated environment for facilitating interaction between the user and a simulated character controlled by a controller;
extracting input information from the computer-recognisable input as extracted input information at least partly by semantic analysis, the step of extracting input information at least partly by semantic analysis further including the step of associating each of a plurality of syntactic units in the input information with a corresponding semantic role; and
causing an action to be generated in response to the computer-recognisable input based at least partly on the extracted input information.

2. A method as claimed in claim 51 wherein the step of extracting input information by linguistic analysis includes the step of converting non-text-based information into text-based information.

3. A method as claimed in claim 1 wherein the step of converting non-text-based information into text-based information includes converting speech into text-based information.

4. A method as claimed in claim 51 wherein the step of extracting input information by linguistic analysis includes the step of identifying spelling errors.

5. A method as claimed in claim 4 wherein the step of identifying spelling errors includes the step of correcting the spelling errors.

6. A method as claimed in claim 51 wherein the step of extracting input information by linguistic analysis includes the step of extracting input information by syntactic analysis.

7. A method as claimed in claim 6 wherein the step of extracting input information by syntactic analysis includes the step of analysing the input information by any one or more of part-of speech tagging, chunking and syntactic parsing.

8. (canceled)

9. A method as claimed in claim 1 wherein the step of extracting information includes the step of extracting fact information.

10. A method as claimed in claim 9 wherein the step of extracting fact information includes determining any one or more of the user's age, company or affiliation, email address, favourites, gender, occupation, marital status, sex orientation, nationality, name or nickname, religion and hobby.

11. A method as claimed in claim 1 wherein the step of extracting information includes the step of extracting emotion information.

12. A method as claimed in claim 11 wherein the step of extracting emotion information includes the step of determining if the user feels angry, annoyed, bored, busy, cheeky, cheerful, clueless, confused, disgusted, ecstatic, enraged, excited, flirty, frustrated, gloomy, happy, horny, hungry, lost, nervous, playful, sad, scared, regretful, surprised, tired or weary.

13. A method as claimed in claim 1 wherein the step of receiving a computer-recognisable input includes the step of receiving a computer-recognisable input generated using an input device.

14. A method as claimed in claim 13 wherein the step of receiving a computer-recognisable input generated using an input device includes the step of receiving a computer-recognisable input generated using any one or more of a keyboard device, a mouse device, a tablet hand-writing device and a microphone device.

15. A method as claimed in claim 1 wherein the step of causing an action to be generated includes the step of causing a task to be performed.

16. A method as claimed in claim 15 wherein the step of causing a task to be performed includes the step of causing a business operation to be performed.

17. A method as claimed in claim 16 wherein the step of causing a business operation to be performed includes the step of causing the balance of a financial account of the user to be checked.

18. A method as claimed in claim 16 wherein the step of causing a business operation to be performed includes the step of causing a financial transaction to take place.

19. A method as claimed in claim 15 wherein the step of causing a task to be performed includes the step of facilitation booking and reservation of on-line accommodation and/or on-line transport.

20. A method as claimed in claim 1 wherein the step of causing an action to be generated includes the step of causing content to be delivered to the user.

21. A method as claimed in claim 20 wherein the step of causing content to be delivered includes the step of causing any one or more of text, an image, a sound, music, an animation, a video and an advertisement to be delivered to the user.

22. A method as claimed in claim 21 wherein the step of causing content to be delivered to the user includes the step of causing content to be delivered via an output device.

23. A method as claimed in claim 22 wherein the step of causing content to be delivered via an output device includes the step of causing content to be delivered via a computer monitor or a speaker.

24. A method as claimed in claim 1 wherein the step of causing an action to be generated includes the step of causing an emotion of the simulated characters to be generated based at least partly on the extracted information.

25. A method as claimed in claim 24 wherein the step of causing an action to be generated includes the step of providing the emotion of the simulated character to the user.

26. A method as claimed in claim 1 wherein the step of causing an action to be generated includes the step of comparing the extracted input information to a plurality of predetermined actions.

27. A method as claimed in claim 26 wherein the step of comparing includes identifying one or more matches or similarities between the extracted input information and one or more of the plurality of predetermined actions.

28. A method as claimed in claim 27 wherein the step of identifying one or more matches or similarities includes the step of identifying one or more matches or similarities on words, patterns of words, syntax, semantic structures, facts and emotions between the extracted input information and the one or more of the plurality of predetermined actions.

29. A method as claimed in claim 26 wherein the step of comparing includes the step of ranking the one or more of the plurality of predetermined actions.

30. A method as claimed in claim 29 wherein the step of ranking includes the step of associating a ranking score to each of the one or more of the plurality of predetermined actions.

31. A method as claimed in claim 1 wherein the step of causing an action to be generated includes the step of retrieving at least one of the one or more of the plurality of predetermined actions.

32. A method as claimed in claim 31 wherein the step of retrieving at least one of the one or more of the plurality of predetermined actions includes the step of retrieving at least one of the one or more of the plurality of predetermined actions based at least partly on the ranking score.

33. A method as claimed in claim 32 wherein the step of retrieving at least one of the one or more of the plurality of predetermined actions based at least partly on the ranking score includes the step of retrieving one or more predetermined actions each with a ranking score larger than a threshold ranking score.

34. A method as claimed in claim 31 wherein the plurality of predetermined actions includes a plurality of manually compiled actions or machine learned.

35. A method as claimed in claim 1 further comprising the steps of:
extracting interaction information from interaction between the user and a character as extracted interaction information, the character being one of a plurality of user characters controlled by a plurality of respective users, or one of a plurality of simulated characters controlled by a plurality of respective controllers; and
storing the extracted interaction information in a user profile associated with the user.

36. A method as claimed in claim 35 wherein the step of causing an action to be generated includes the step of causing an action to be generated based at least partly on the user profile.

37. A method as claimed in claim 35 wherein the step of extracting interaction information includes the step of extracting interaction information at least partly by linguistic analysis or semantic analysis.

38. A method as claimed in claim 37 wherein the step of extracting interaction information at least partly by linguistic analysis or semantic analysis includes the step of ranking information associated with user actions and stored in the user profile according to frequencies of the user actions.

39. A method as claimed in claim 35 further comprising the step of updating the user profile by repeating the steps of extracting interaction information and storing the extracted interaction information.

40. A method as claimed in claim 1 wherein the step of causing an action to be generated includes determining inconsistencies between the extracted input information and the user profile.

41. A method as claimed in claims 39 wherein the step of causing an action includes, if an inconsistency is determined to exist, the step of generating a query associated with the inconsistency to the user.

42. A method as claimed in claim 36 wherein the step of storing the extracted interaction information in a user profile associated with the user includes storing the user profile in an electronic database.

43. A method as claimed in claim 36 wherein the user profile includes fact information about the user and/or personal characteristics about the user.

44. A method as claimed in claim 1 further comprising the steps of:
allocating the user to a user group having a plurality of group users sharing similar or same interaction information stored in a plurality of respective user profiles; and
storing the similar or same interaction information in a user group profile associated with the user group.

45. A method as claimed in claim 42 wherein the step of causing an action to be generated includes causing an action to be generated based at least partly on the user group profile.

46. A method as claimed in claim 1 wherein the computer-simulated environment includes any one or more of a virtual world, an online gaming platform, an online casino and chat rooms.

47. A method as claimed in claim 1 wherein the interaction includes any one or more of conversations, game playing, interactive shopping and virtual world activities.

48. A method as claimed in claim 47 wherein the virtual world activities include virtual expos or conferences, virtual educational, tutorial or training events or virtual product or service promotion.

49. A system for providing a computer-generated response, the system comprising a processor programmed to:
receive a computer-recognisable input originating from a user of a computer-simulated environment for facilitating interaction between the user and a simulated character controlled by a controller;
extract input information from the computer-recognisable input as extracted input information at least partly by semantic analysis, which includes associating each of a plurality of syntactic units in the input information with a corresponding semantic role; and
cause an action to be generated in response to the computer-recognisable input based at least partly on the extracted input information.

50. A computer or machine readable medium with instructions for providing a computer-generated response, the instructions adapted to instruct a computer or a machine to execute the steps of
receiving a computer-recognisable input originating from a user of a computer-simulated environment for facilitating interaction between the user and a simulated character controlled by a controller;
extracting input information from the computer-recognisable input as extracted input information at least partly by semantic analysis, which includes associating each of a plurality of syntactic units in the input information with a corresponding semantic role; and
causing an action to be generated in response to the computer-recognisable input based at least partly on the extracted input information.

51. A method as claimed in claim 1, wherein the step of extracting input information at least partly by semantic analysis includes the step of also extracting input information by linguistic analysis.
